(19) United States
(12) Patent Application Publication
(10) Pub. No.: US 2021/0247625 A1
(43) Pub. Date: Aug. 12, 2021

(54) EYEWEAR DESIGN WITH TEMPLE RETENTION FEATURES

(71) Applicant: Troy Adam Devore, Fitchburg, WI (US)

(72) Inventor: Troy Adam Devore, Fitchburg, WI (US)

(21) Appl. No.: 17/073,928

(22) Filed: Oct. 19, 2020

Related U.S. Application Data
(60) Provisional application No. 62/922,597, filed on Aug. 19, 2019.

(51) Int. Cl. G02C 5/16

(52) U.S. Cl. CPC G02C 5/16

(57) ABSTRACT

An eyewear assembly is provided. The eyewear assembly includes a continuous lens part having a curved shape that extends from a first end to a second end. The eyewear assembly further includes a pair of temple retention arms hingably coupled to the continuous lens part. Each of the pair of temple retention arms is configured to pivot between a closed position and an opened position, and each of the pair of temple retention arms is configured to contact a temple of a user to retain the eyewear assembly on the user.

### CROSS-REFERENCE TO RELATED APPLICATION

The present application claims priority to and the benefit of U.S. Provisional Application Ser. No. 62/922,597, filed Aug. 19, 2019, which is hereby incorporated by reference herein in its entirety.

### FIELD

The present disclosure relates generally to eyewear and/or eyeglasses. More specifically, the present disclosure relates to an improved eyewear assembly that rests directly against a user's temples rather than over the user's ears.

### BACKGROUND

Existing eyeglass frames generally include a lens portion that contacts a user's nose and arms that extend rearwardly from the lens portion and rest on top of the user's ears. The pressure on these contact points can make wearing eyeglasses uncomfortable, particularly during long periods of use, when the frames are fabricated from heavy material, or when the dimensions of the frames are not precisely fitted to the user. Alternative eyewear designs, for example, goggle-type eyewear that is secured to the user using an elastic material that extends around the back of the user's head, are similarly uncomfortable and unattractive. An attractive eyewear alternative that relieves pressure on the user's nose and ears would therefore be useful.

### SUMMARY

This Summary is provided to introduce a selection of concepts that are further described herein below in the Detailed Description. This Summary is not intended to identify key or essential features of the claimed subject matter, nor is it intended to be used as an aid in limiting the scope of the claimed subject matter.

According to one implementation of the present disclosure, an eyewear assembly is provided. The eyewear assembly includes a continuous lens part having a curved shape that extends from a first end to a second end. The eyewear assembly further includes a pair of temple retention arms hingably coupled to the continuous lens part. Each of the pair of temple retention arms is configured to pivot between a closed position and an opened position, and each of the pair of temple retention arms is configured to contact a temple of a user to retain the eyewear assembly on the user.

### BRIEF DESCRIPTION OF THE DRAWINGS

The present disclosure is described with reference to the following Figures. The same numbers are used throughout the Figures to reference like features and like components.

FIG. 1 is a perspective view of an eyewear assembly having temple retention arms.

FIG. 2 is a bottom perspective view of the eyewear assembly of FIG. 1.

FIG. 3 is a rear view of the eyewear assembly of FIG. 1 with the temple retention arms in a closed position.

FIG. 4 is an exploded view of the eyewear assembly of FIG. 1.

FIG. 5 is a detail view of one of the temple retention arms utilized in the eyewear assembly of FIG. 1.

FIG. 6 is a top view of one of the temple retention arms utilized in the eyewear assembly of FIG. 1 pivoting to an opened position.

FIG. 7 is another top view of one of the temple retention arms utilized in the eyewear assembly of FIG. 1 in the opened position.

FIG. 8 is a perspective view of the eyewear assembly of FIG. 1 as worn by a user.

### DETAILED DESCRIPTION

In the present description, certain terms have been used for brevity, clearness and understanding. No unnecessary limitations are to be inferred therefrom beyond the requirement of the prior art because such terms are used for descriptive purposes only and are intended to be broadly construed.

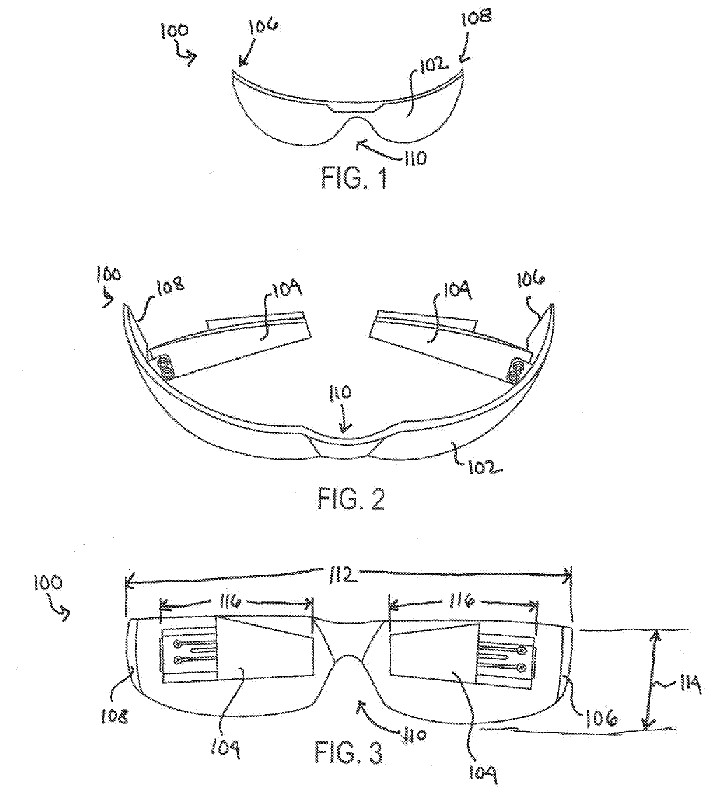

FIGS. 1-3 depict an exemplary eyewear assembly 100. The eyewear assembly 100 is shown to include a continuous lens part 102 that is coupled to a pair of temple retention arms 104. The continuous lens part 102 is shown to have an overall curved shape that extends from a first end 106 to a second end 108. At a midpoint between the first end 106 and the second end 108, the lens part 102 includes a narrowed region 110 to accommodate a user's nose. The profile of the continuous lens part 102 on either side of the narrowed region 110 is not particularly limited and may have any desired shape (e.g., curved, square) to suit the taste and needs of the wearer. Advantageously, the continuous lens part 102 is fabricated as a single part, providing the eyewear assembly 100 with a sleek, attractive appearance.

As best depicted in FIGS. 2 and 3, the temple retention arms 104 are shown to be coupled to the lens part 102 inwardly of the first end 106 and the second end 108. Unlike the arms of traditional glasses frames, the temple retention arms 104 are only intended to extend to the temple region of a user's head when worn, rather than over a user's ears. Accordingly, the temple retention arms 104 do not contact or overlap with each other when the retention arms 104 are pivoted to the closed position, as depicted in FIGS. 2 and 3. In an exemplary implementation, the overall width 112 of the eyewear assembly 100 is approximately (i.e., ±15%) 130 mm, the overall height 114 is approximately 21 mm, and a width 116 of each temple retention arm 104 is approximately 47 mm. As such, the width 116 of each temple retention arm 104 is less than half of the overall width 112 of the eyewear assembly 100. However, each of the dimensions 112, 114, 116 may be larger or smaller to accommodate the head size of the wearer.

The continuous lens part 102 may be fabricated from any suitable lens material (e.g., polycarbonate, nylon) and the temple retention arms 104 may be fabricated from a thermoplastic material, for example, polylactic acid (PLA) bioplastic using any suitable fabrication process (e.g., injection molding, 3-D printing). The inventor has recognized that PLA exhibits good strength, has a low rate of thermal expansion, and is sufficiently flexible for the present application to accommodate different user head shapes and sizes. In other implementations, a different thermoplastic material may be utilized for the temple retention arms 104.

In an exemplary implementation, the continuous lens part 102 may be tinted a black, gray, or brown shade such that the eyewear assembly 100 functions as sunglasses. The lens part 102 may also be coated with a UV-blocking material. In other implementations, the continuous lens part 102 may be untinted or colorless such that the eyewear assembly 100 functions as corrective eyewear for persons with myopia, hyperopia, or astigmatism, or as protective eyewear for industrial or scientific environments, among others. Advantageously, the curved shape of the continuous lens part 102 permits the eyewear assembly 100 to fit closely to the user's head, thus eliminating the gaps that may be present between a user's head and traditional safety goggles. In some implementations, the continuous lens part 102 may include a seal material (e.g., foam, rubber) that further reduces gaps between the eyewear assembly 100 and the user's head.

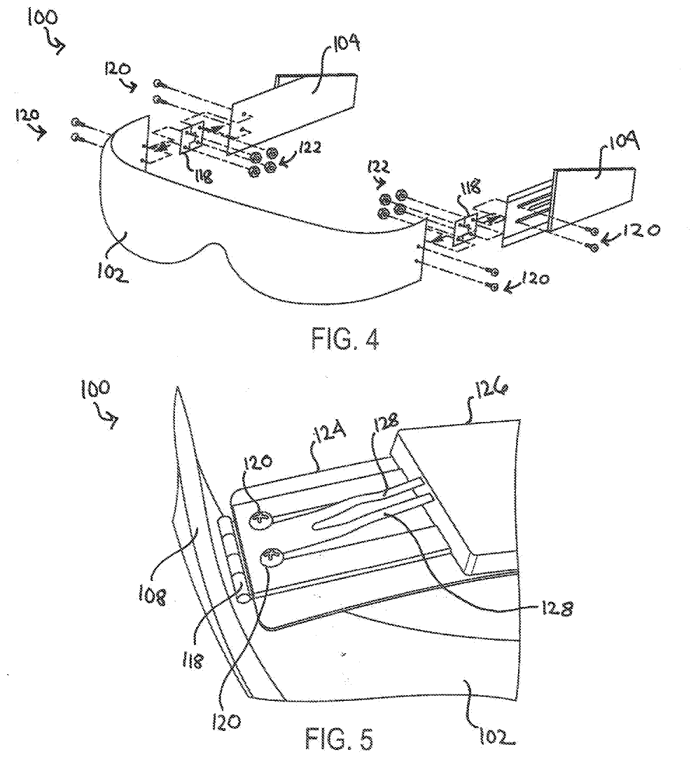

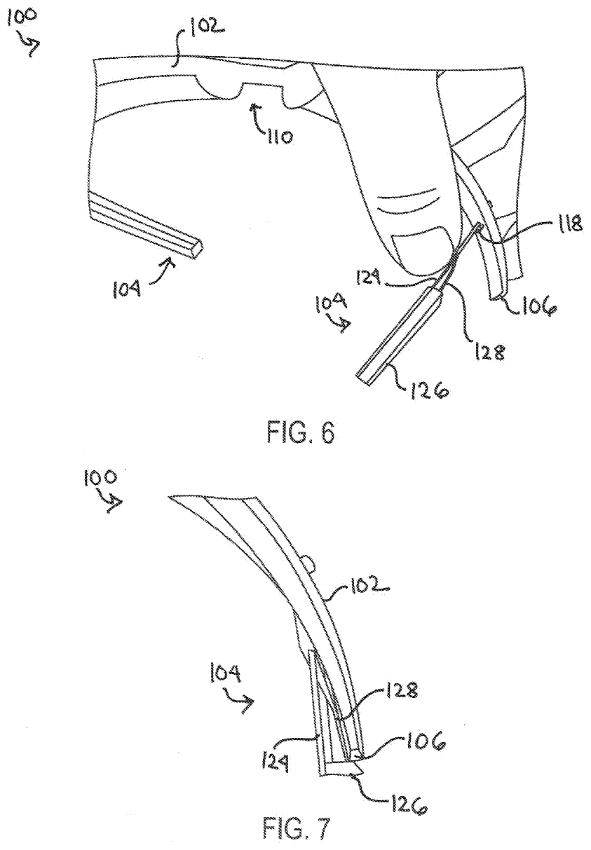

Turning now to FIG. 4, an exploded view of the eyewear assembly 100 is depicted. As shown, in an exemplary implementation, each of the temple retention arms 104 may be coupled to the continuous lens part 102 using a hinge component 118. The hinge component 118 may be any suitable type of hinge, for example, a piano or continuous-style hinge that permits the temple retention arms 104 to rotate from a closed position (depicted in FIG. 2) to an opened position (depicted in FIGS. 6-8). The hinge component 118 may be coupled to the lens part 102 and the temple retention arms 104 using multiple screws 120 secured by nuts 122, although in other embodiments, a different style of fastener (e.g., pins) or an adhesive may be utilized. In other embodiments, the eyewear assembly 100 may be fabricated as a single part, with temple retention portions coupled to a lens portion using living hinges.

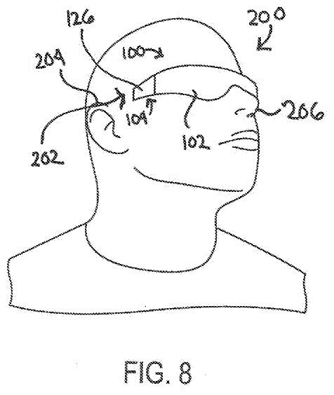

Referring now to FIGS. 5-7, detail views of the temple retention arms 104 are shown. Each temple retention arm 104 is shown to include a relatively thin inner portion 124 that is proximate the hinge component 118 and a relatively thick outer portion 126. A thickness of the outer portion 126 may be selected such that when the temple retention arm 104 is pivoted to the opened position, as depicted in FIGS. 6 and 7, the inner portion 124 is situated between the user and one of the ends 106, 108 of the lens part 102, and the outer portion 126 forms a smooth and continuous curved profile with the lens part 102 (see also FIG. 8). Although the outer portion 126 is shown to have a generally trapezoidal shape, in other implementations, the outer portion 126 may have another shape (e.g., rectangular, oblong) to achieve a desired appearance.

A spring flange 128 is shown to be situated proximate the inner portion 124. The spring flange 128 includes one or more spring prongs is configured to be compressed by the first end 106 or the second end 108 of the lens part 102 when the retention arm 104 is pivoted to the opened position (see FIG. 7) to accommodate variations in user head size and shape and achieve a secure fit. In an exemplary implementation, the spring flange 128 is fabricated from metal (e.g., aluminum), although in other implementations, a compressible material (e.g., foam) may be utilized in place of the spring flange 128.

FIG. 8 depicts the eyewear assembly 100 as worn by a user 200. As described above, when the temple retention arms 104 are in the opened position, the outer portions 126 of the retention arms 104 are generally continuous with the lens part 102, giving the eyewear assembly 100 a sleek and attractive look. In addition, because the temple retention arms 104 exert a slight compressive force on the user's temples 202 (i.e., the region of the user's face positioned forward and above the user's ears 204 to retain the eyewear assembly 100 on the user's head, the weight of the eyewear assembly 104 does not rest on the user's nose 206 or ears 204, resulting in a more comfortable fit than traditional eyewear.

In the present disclosure, certain terms have been used for brevity, clearness and understanding. No unnecessary limitations are to be implied therefrom beyond the requirement of the prior art because such terms are used for descriptive purposes only and are intended to be broadly construed. The different systems and methods described herein may be used alone or in combination with other systems and devices. Various equivalents, alternatives and modifications are possible within the scope of the appended claims.

What is claimed is:

1. An eyewear assembly, comprising:
a continuous lens part having a curved shape and extending from a first end to a second end; and
a pair of temple retention arms hingably coupled to the continuous lens part, each of the pair of temple retention arms configured to pivot between a closed position and an opened position;
wherein each of the pair of temple retention arms is configured to contact a temple of a user to retain the eyewear assembly on the user.

2. The eyewear assembly of claim 1, wherein each of the pair of temple retention arms is hingably coupled to the continuous lens part inwardly of the first end or the second end.

3. The eyewear assembly of claim 1, wherein each of the pair of temple retention arms has a width that is less than half of an overall width of the eyewear assembly.

4. The eyewear assembly of claim 1, wherein the continuous lens part further comprises a narrowed portion at a midpoint between the first end and the second end.

5. The eyewear assembly of claim 1, wherein each of the pair of temple retention arms further comprises an inner portion and an outer portion, wherein the inner portion is situated between the temple of the user and the first end or the second end when the pair of temple retention arms are in the opened position.

6. The eyewear assembly of claim 5, wherein a thickness of the outer portion is greater than a thickness of the inner portion.

7. The eyewear assembly of claim 5, wherein the each of the pair of temple retention arms further comprises a spring flange situated proximate the inner portion and configured to be compressed by the first end or the second end when the pair of temple retention arms are in the opened position.

8. The eyewear assembly of claim 1, wherein the continuous lens part is tinted such that the eyewear assembly is configured to function as sunglasses.

9. The eyewear assembly of claim 1, wherein the continuous lens part is untinted such that the eyewear assembly is configured to function as protective eyewear.

10. The eyewear assembly of claim 1, wherein each of the pair of temple retention arms is at least partially fabricated from polylactic acid (PLA).
